(19) United States
(12) Patent Application Publication
(10) Pub. No.: US 2007/0221667 A1
(43) Pub. Date: Sep. 27, 2007

(54) Buffet sever

(76) Inventor: Tian kun Xu, Zhejiang (CN)

Correspondence Address: RABIN & Berdo, PC, 1101 14TH STREET, NW, SUITE 500, WASHINGTON, DC, 20005, US

(21) Appl. No.: 11/373,130

(22) Filed: Mar. 13, 2006

(51) Int. Cl. H05B 6/80

(52) U.S. Cl. 219/730

(57) ABSTRACT

A buffet sever (100) includes a base (10) with a heating device, a food tray (40) which the food items is disposed, and a receptacle (20) for holding heating mediums. The receptacle is set on the base. A bottom or a wall of the food tray is immersed in the heating medium of the receptacle. The heating device is used for heating the food items in the food tray through heating the heating medium in the receptacle. The food items can be uniformly heated since using fluid as heating medium, and the temperature of the food items can be easily controlled. Then, the food items in the food tray will not be over heated or burnt, and can keep good taste.

### FIELD OF THE INVENTION

The present invention relates generally to a buffet server and more specifically to a buffet server which can maintaining food items at required temperatures.

### BACKGROUND OF THE INVENTION

In our daily life, self-service food displays or buffet severs are usually used to present food items to diners. The food will become cool when being presented for a period of time, especially in winter, so that the dinner cannot have hot food. People often send the cold food items back to be heated once again using cooking range, or using microwave oven. However, such heating methods are not convenient, or even not available, and the food items may not taste good after heating again using such methods.

Therefore, an improved structure of a buffet sever is desired which overcomes the disadvantages of the prior art.

### SUMMARY OF THE INVENTION

An object of the present invention is to provide a buffet sever that maintains a uniform temperature for the display food items.

A buffet sever comprises a base with a heating device, a food tray in which the food items is disposed, and a receptacle for holding heating mediums. The receptacle is set on the base. The bottom or the wall of the food tray is immersed in the heating medium of the receptacle. The heating device is used for heating the food items in the food tray through heating the heating mediums in the receptacle.

### BRIEF DESCRIPTION OF THE DRAWINGS

Other and further objects, advantages and novel features of the invention will become more apparent by reference to the following specification in conjunction with the accompanying drawing, in which like reference characters denote like elements of structure and:

FIG. 1 is an exploded, perspective view of a buffet sever in accordance with an embodiment of the present invention.

### DESCRIPTION OF THE PREFERRED EMBODIMENT

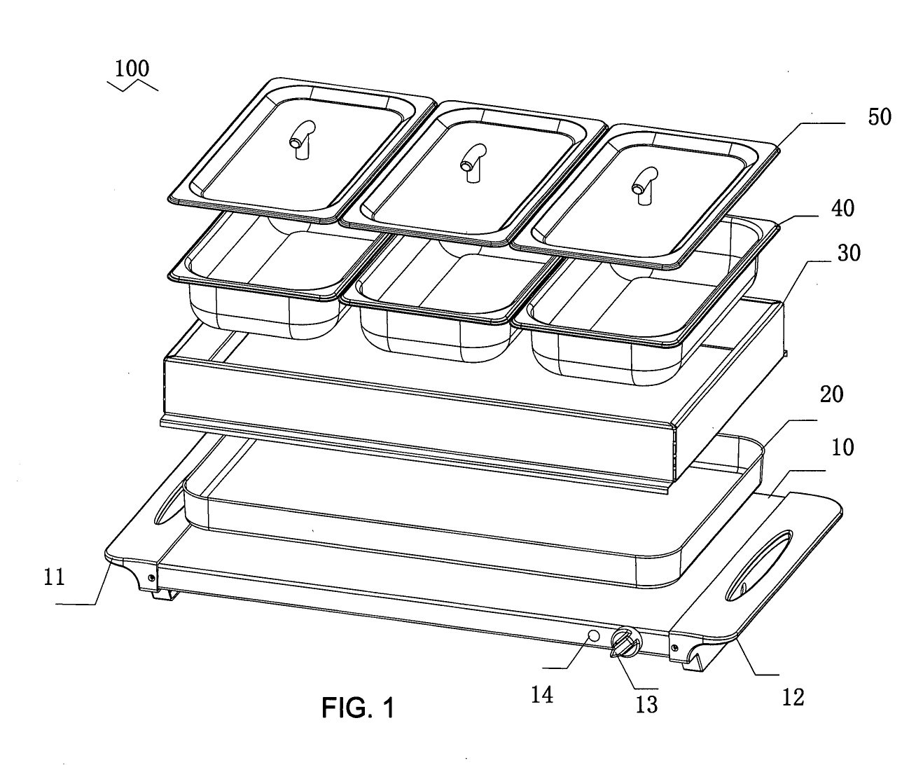

Referring now to the drawing in detail, FIG. 1 shows a buffet sever 100. The buffet sever 100 comprises a base 10, a water receptacle 20, a frame 30, food trays 40, and covers 50.

The base 10, which substantially has a rectangular shape in the preferred embodiment, has left and right handles 11, 12 at left and right ends thereof, and has a knob 13 for controlling heating temperatures and an indicator light 14 for indicating heating work in a front panel thereof. Furthermore, the base 10 includes a heating device (not shown). Such heating device is known to those of skill in the art, and produces heat using electricity, far-infrared, fuel, etc. A carriage may be set for housing the heating device therein.

The water receptacle 20 is set on the base 10 for holding heating medium, and can be removably or irremovably fastened to the base 10. A predetermined interval can be set between the wall of the receptacle 20 and the fringe of the base 10 on the upper surface of the base 10, so that the frame 30 can be inserted thereinto and around the periphery of the water receptacle 20.

The frame 30, which is used to support food trays 40, is set around the periphery of the water receptacle 20 and is blocked between the frame 30 and the base 10 on the upper surface of the same in the preferred embodiment.

The number of food trays 40 and covers 50 can be one or more than one in use. An upper flange of the food tray 40 is supported on the frame 30. The cover 50 is removably coupled to the food tray 40 using clip or groove mechanisms or the like, or just is placed on the food tray 40.

When being assembled, the water receptacle 20 and the frame 30 is respectively set onto the base 10. Hereinto, the water receptacle 20 can be irremovably positioned on the base 10 using welding, integral molding, or the like. The water receptacle 20 can also be removably fastened onto the base 10 using clip, groove, thread, rivet mechanisms, or the like. Additionally, the water receptacle 20 can also be free placed on the upper surface of the base 10, and then is fixed by the frame 30. Similarly, the frame 30 can be irremovably fastened onto the base 10 using welding, integral molding or the like, or can be removably fastened onto the base 10 and around the periphery of the water receptacle 20 using clip, groove, thread, rivet mechanisms or the like. The food trays 40 are irremovably fixed on the frame 30 using welding, integral molding or the like, or are removably fastened on the same using clip, groove, thread, rivet mechanisms or the like, or are just free placed thereon, so that the bottom or the wall of the food tray 40 is immersed in the water of the receptacle 20.

When the buffet sever is in use, water is poured into the receptacle 20, the heating device is started. The degree of heating can be adjusted using the knob 13. The heated water in the receptacle 20 heats the food items in the food tray 40.

The food items can be uniformly heated since using fluid as heating medium, and the temperature of the food items can be easily controlled since the temperature of the heated water does not exceed over 100 centigrade degrees at a usual atmospheric pressure. Therefore, the food items in the food tray 40 cannot be over heated or burnt, and can keep good taste. The temperature of the heated water may exceed 100 centigrade degrees according to the pressure if desire.

As alternate embodiments, the heating medium can also be oil, steam, or a mixture of water and steam, or other heating medium as known in the art.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A buffet sever comprising:
a base with a heating device;
a food tray for disposing food items; and
a receptacle for holding heating medium;
wherein said receptacle is set on the base; a bottom or a wall of said food tray is immersed in the heating mediums of the receptacle; and the heating device is used for heating the food items in the food tray through heating the heating medium in the receptacle.

2. The buffet sever as claimed in claim 1, wherein the receptacle for holding heating mediums is irremovably fastened to the base using welding or integral molding; or is removably fastened to the base using clip, groove, thread, or rivet mechanism.

3. The buffet sever as claimed in claim 1, further comprising a frame for supporting the food tray.

4. The buffet sever as claimed in claim 3, wherein the frame is couple to the receptacle for holding the heating medium.

5. The buffet sever as claimed in claim 4, wherein the frame is set on the base.

6. The buffet sever as claimed in claim 5, wherein the frame is set between the receptacle and a flange on a top surface of the base.

7. The buffet sever as claimed in claim 6, wherein the frame is irremovably fastened onto the base using welding or integral molding, or is removably fastened onto the base and around a periphery of the receptacle using clip, groove, thread or rivet mechanism.

8. The buffet sever as claimed in claim 6, wherein the food tray is irremovably fastened onto the frame using welding or integral molding, or is removably fastened onto frame using clip, groove, thread or rivet mechanism.

9. The buffet sever as claimed in claim 1, wherein the heating medium is fluid, steam, or a mixture of fluid and steam.

10. The buffet sever as claimed in claim 9, wherein the heating medium is water, oil, steam, or a mixture of water and steam.

11. The buffet sever as claimed in claim 1, wherein the heating device produces heat using electricity, far-infrared, microwave or fuel.

12. The buffet sever as claimed in claim 1, wherein the base has left and right handles at left and right ends of the base, and a knob and a indicating light on a front panel of the base.

13. A buffet sever comprising:
a base with a heating device;
a plurality of food trays for disposing food items; and
a receptacle for holding heating medium;
wherein the receptacle is set on the base; and the heating device is used for heating the food items in the food tray through heating the heating medium in the receptacle.

14. The buffet sever as claimed in claim 13, wherein a plurality of cover is set to the plurality of food trays.

15. The buffet sever as claimed in claim 13, further comprising a frame for supporting the plurality of food trays.

16. The buffet sever as claimed in claim 15, wherein the frame is positioned on the base.
